(19) United States
(12) Patent Application Publication
(10) Pub. No.: US 2004/0263656 A1
(43) Pub. Date: Dec. 30, 2004

(54) Process for sampling the signal delivered by an active pixel of an image sensor, and corresponding sensor

(75) Inventor: Laurent Simony, Grenoble (FR)

Correspondence Address: JENKENS & GILCHRIST, PC, 1445 ROSS AVENUE, SUITE 3200, DALLAS, TX, 75202, US

(73) Assignee: STMicroelectronics S.A., Montrouge (FR)

(21) Appl. No.: 10/827,094

(22) Filed: Apr. 19, 2004

(30) Foreign Application Priority Data
Apr. 30, 2003 (FR) 0305363

(51) Int. Cl. H04N 5/335

(52) U.S. Cl. 348/308

(57) ABSTRACT

The sampling of a pixel signal by a sampling capacitor is effectuated by applying to the sampling capacitor a voltage equal to the corresponding pixel voltage minus the value of the gate-source voltage of a follower transistor biased with a predetermined constant bias current for a first predetermined duration so as to obtain for the sampling capacitor a final state of stable charge. The bias current is then interrupted. Lastly, the end of the sampling pulse occurs on completion of a second predetermined duration after the said interruption of the current.

### PRIORITY CLAIM

The present application claims priority from French Application for Patent No. 03 05363 filed Apr. 30, 2003, the disclosure of which is hereby incorporated by reference.

### BACKGROUND OF THE INVENTION

1. Technical Field of the Invention

The present invention relates to processing of signals delivered by a matrix of pixels of an image sensor, and more particularly, to improving the performance in terms of dynamics and noise of the sampling of the signal emanating from a matrix of active pixels that is embodied in CMOS technology.

2. Description of Related Art

An image sensor conventionally comprises a matrix of pixels. Each pixel delivers an electrical signal whose level depends on the quantity of light received by the pixel. This signal is conventionally stored in a pair of sampling capacitors and then it is, for example, amplified in a readout amplifier.

Traditionally, the noise floor of a CMOS image sensor was limited by the pixel reinitialization noise, which is of the order of 1 millivolt rms. Solutions now exist for overcoming this noise. So, the limitation as regards noise is now shifted to the level of the samplers. More precisely, the passage of the bias current through the pixel follower transistor causes white noise, whose bandwidth is limited by the impedance of the transistor and the total capacitance of the sampling capacitor (for example, of the order of 0.5 pF) and of the column (bit line) (for example of the order of 1 pF). However, this current is dimensioned in respect of speed and accuracy constraints, and it is typically of the order of 1 microampere, thus making it possible to sample in approximately one microsecond.

Moreover, the current source also participates in the white noise. At present, this white noise has a mean value estimated at approximately 150 microvolts.

Additionally, the larger the gate-source voltage of the follower transistor, the more limited the usable signal range. Also, the gate-source voltage is related to the square root of the ratio of the current of the follower transistor to a coefficient dependent on the technological characteristics of the transistor. However, having regard to the dimensional constraints of the pixel, this technological coefficient can scarcely be increased in practice. Consequently, the current which passes through the follower transistor fixes the value of the gate-source voltage Vgs. One is accordingly constrained to have a high gate-source voltage, the consequence being the clipping of the sampled signal.

There is a need in the art to solve this problem. There is also a need to reduce the sampling noise. Still further, there is a need to reduce the gate-source voltage of the follower transistor in such a way as to utilize more useful signal without clipping.

### SUMMARY OF THE INVENTION

One embodiment of the invention proposes a process for sampling the signal delivered by an active pixel of an image sensor. The image sensor comprises a phase of storage of the signal in a pair of sampling capacitors comprising two successive respective effective electrical links of the two sampling capacitors with a follower transistor tracking the pixel in the course of the two respective sampling pulses corresponding respectively to two successive different levels of pixel voltage that are applied to a gate of the follower transistor.

According to a general characteristic of the invention, the process for the storage phase comprises for each sampling capacitor:

application to this sampling capacitor of a voltage equal to the corresponding pixel voltage minus the value of the gate-source voltage of the follower transistor biased with a predetermined constant bias current, for a first predetermined duration so as to obtain for the said sampling capacitor a final state of stable charge,

interruption of the bias current, and

terminating the sampling pulse occurring on completion of a second predetermined duration after the said interruption of the current.

Thus, according to the invention, once the final state of charge has been obtained for each sampling capacitor, the bias current is cut off. Consequently, the gate-source voltage becomes equal to first order to the threshold voltage of the follower transistor. There is consequently less gate-source voltage, thereby making it possible to utilize more useful signal without clipping. Moreover, the white noise contributions due to this bias current disappear with the latter and this consequently results in reduced sampling noise.

More precisely, after interruption of the bias current, the variation in voltage in the bit line is positive and the current required to produce this variation passes through the follower transistor. This current is very weak and the follower transistor is weakly reverse-biased. In this operating zone, the noise band is much reduced and the noise spectral density exhibits a lower amplitude, hence a considerable improvement in the noise.

The second duration is advantageously chosen in such a way as to obtain at the end of each sampling pulse, a residual current flowing through the follower transistor less than a predetermined threshold corresponding to a predetermined threshold level of the noise of the follower transistor.

Thus, by way of indication, the predetermined threshold level for the noise of the follower transistor lies between approximately 50 and 100 microvolts.

Moreover, the first duration is a fraction of the duration of the sampling pulse, the bias current then being greater than a predetermined threshold.

Thus, according to one mode of implementation of the invention, in which the duration of the sampling pulse is of the order of one microsecond, the first duration may be of the order of 100 nanoseconds, and the bias current of the order of 10 microamperes. This makes it possible, by using a current approximately 10 to 20 times greater than a bias current used in the prior art, to reach stabilization all the more rapidly in respect of the state of charge of each sampling capacitor.

In a general manner, according to the invention, the voltages reached on the sampling capacitors depend only on the two different levels of pixel voltage. The principle is therefore deterministic.

The high current, advantageously used before cut-off, is an element that participates in the obtaining of this deterministic principle.

Likewise, it is advantageous to precharge each sampling capacitor to a predetermined initial value before each sampling pulse. Thus, the precharge makes it possible to begin each sampling from a deterministic state. Specifically, as soon as the current is cut off, the final voltage to which one tends depends on the initial voltage. The precharge makes it possible to lose all “memory” of the voltage sampled in the previous cycle.

The invention also proposes an image sensor, comprising a matrix of active pixels, and means for processing the information delivered by the said matrix of active pixels, the processing means comprising a pair of sampling capacitors per column of the matrix that are able to be respectively linked electrically to the follower transistor tracking each pixel of the column in the course of two respective sampling pulses corresponding respectively to two successive different levels of pixel voltage that are applied to the gate of the follower transistor.

According to a general characteristic of the invention, the processing means comprise a current source connected to each column of the matrix, and able to deliver on command to the said column a predetermined constant bias current, and control means able for each sampling capacitor and in the course of the corresponding sampling pulse:

energize the column with the said bias current for a first predetermined duration so as to obtain for the said sampling capacitor a final state of stable charge,

then interrupt the energizing of the said column by the bias current, and

end the sampling pulse occurring on completion of a second predetermined duration after the said interruption of the current.

According to one embodiment of the invention, the current source is connected to the said column by an interrupter controllable by the control means.

According to one embodiment of the invention, the processing means comprise precharging means able to precharge each sampling capacitor to a predetermined initial value before each sampling pulse.

More precisely, by way of indication, when each sampling capacitor possesses a terminal linked to ground, the precharging means comprise two additional controllable interrupters able to link respectively the other two terminals of the two sampling capacitors to ground.

This said, it is appropriate to note here that the precharging of the capacitors is not indispensable but makes it possible to gain time to obtain a deterministic state at the end of the first duration. Specifically, with this precharge, since one starts from a deterministic state right from the beginning of the first duration, so will it also be on completion of this first duration.

Likewise, the use of a larger bias current than the customary value also makes it possible to gain time in the obtaining of this deterministic state.

Having regard to the fact that the phenomenon occurring over the second duration is slow, the use in particular of a high bias current, makes it possible to obtain a total duration (first duration+second duration) equivalent to the sample acquisition duration customarily used in the prior art (for example, one microsecond).

However, the advantages of the invention as regards noise reduction in particular, may also be obtained without high value of bias current or precharge, by simply employing a bigger sample acquisition duration.

The invention also proposes an image acquisition device, for example a video camera, comprising at least one image sensor as defined hereinabove.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIG. 1 is a schematic of an image sensor according to the invention;

FIG. 2 illustrates in greater detail a part of the image sensor of FIG. 1; and

FIG. 3 illustrates a time chart representative of a mode of implementation for the invention.

### DETAILED DESCRIPTION OF THE DRAWINGS

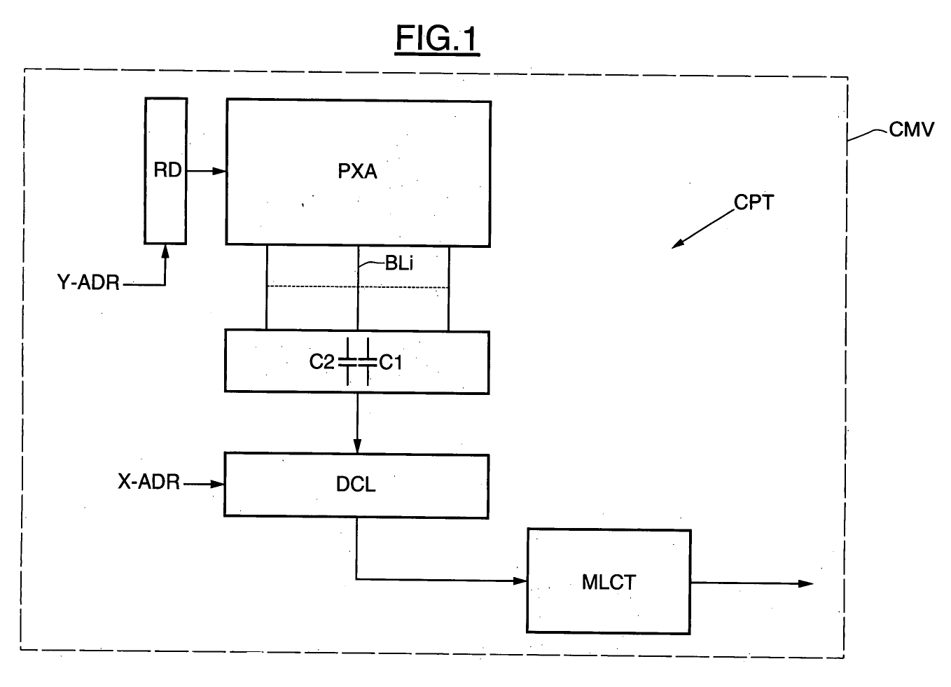

In FIG. 1, the reference CPT designates an image sensor incorporated for example into a video camera CMV.

The image sensor CPT comprises a pixel matrix PXA organized in rows and columns.

A row decoder RD makes it possible to select the rows of the matrix while a column decoder DCL makes it possible to select the columns BLi (bit line) of the matrix.

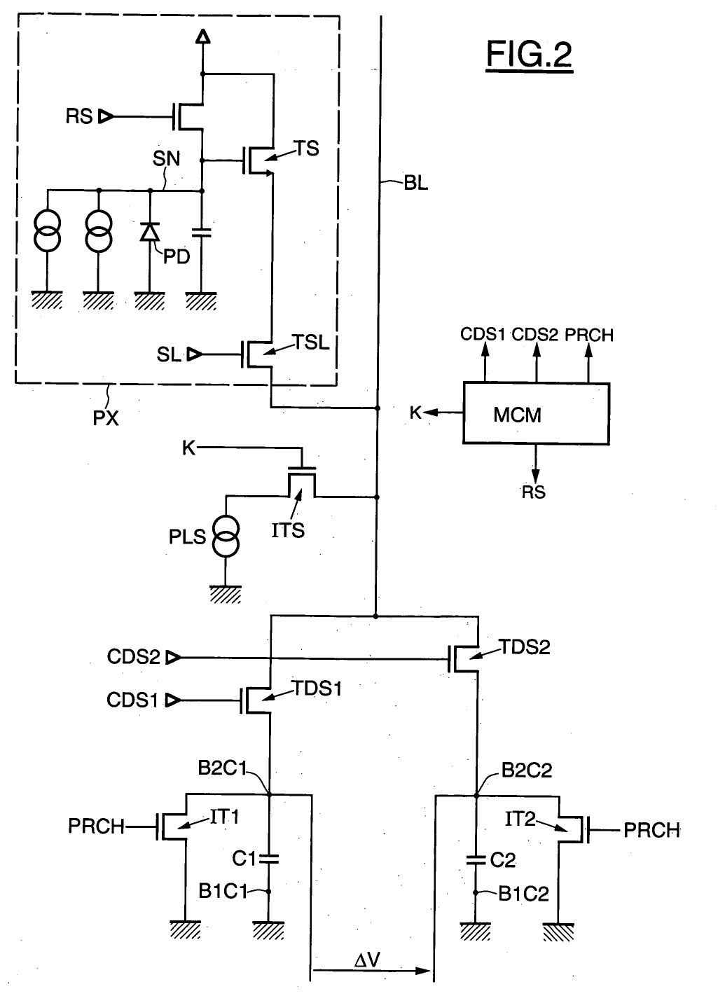

Moreover, a pair of sampling capacitors C1, C2 is connected to each column of the matrix by way of sampling transistors, as is illustrated in FIG. 2.

Finally, reading means MLCT of conventional structure are known per se and allow reading of the charges stored in the sampling capacitor C1, C2. Such reading means may exhibit an architecture allowing voltage-wise reading of the pixel signal, or else an architecture allowing physical transfer of the charges contained in the sampling capacitors into two feedback capacitors connected between the inputs and the outputs of a differential readout amplifier. Such an architecture is for example described in French patent application No. 0300360, the disclosure of which is hereby incorporated by reference. The readout means may also conventionally comprise one analog/digital converter per column.

If reference is now made more particularly to FIG. 2, it may be seen that each pixel PX comprises a photodiode PD whose cathode is linked to a capacitor (consisting essentially of the diode's own capacitance, that is to say the capacitance of the PN junction of the diode) as well as to the supply voltage by way of a transistor controlled by a reset signal RS. The cathode of the photodiode PD is also linked to the gate of a follower transistor TS connected to a bit line (column) BL by way of a line selection transistor TSL. This transistor TSL is controlled by a line selection signal SL.

The biasing of the follower transistor TS is effected by bias means PLS connected to the bit line BL. The bias means PLS here comprise a current source and the latter is connected to the bit line BL by way of an interrupter ITS, formed for example of a MOS transistor, controlled by a signal K.

Moreover, at the base of the column BL are connected the two sampling capacitors C1 and C2. In this embodiment, the two terminals B1C1 and B1C2 of the two capacitors C1 and C2 are linked to ground. Moreover, the other terminal B2C1 of the capacitor C1 is linked to the pixel PX by way of a transistor TDS1 controlled on its gate by a control signal CDS1. Likewise, the other terminal B2C2 of the capacitor C2 is linked to the pixel PX by way of a transistor TDS2 controlled on its gate by a control signal CDS2. Moreover, the terminals B2C1 and B2C2 of the two sampling capacitors C1 and C2 may be respectively connected likewise to ground by way of two additional interrupters IT1 and IT2 both controlled by a signal, here dubbed the precharge signal, PRCH.

All the control signals are delivered by control means MCM, embodied for example from voltage sources and logic gates.

The pixel PX is said to be “active” since it contains an amplification device formed in this example by the follower transistor TS. Although only an exemplary active pixel architecture has been represented in FIG. 2, the luminous signal sensed by the pixel may be in a general manner modeled by a voltage generator applying two different voltage levels Vᵢ (initial) and V_{f} (final) to the gate of the transistor TS in succession. The useful signal Vs (at the pixel level) thus corresponds to the difference between these two levels Vᵢ and V_{f}.

The transistor TSL is, when it is on, a conducting interrupter, thereby making it possible to connect the source of the follower transistor TS to the bit line. At a given instant, only one pixel is connected thereto, in this instance it is the one belonging to the selected row.

In a conventional manner known per se, the bias current provided by the source PLS biases, current-wise, the follower transistor TS of the pixel of the selected row. This transistor TS is therefore biased as a follower. Consequently, the potential of its source reproduces that of its gate, to within an offset Vgs. Stated otherwise, the signal voltage Vs is reproduced on the bit line, to within an offset Vgs. The voltage VBL on the bit line BL is therefore equal to Vs−Vgs.

Moreover, when the signal Vs provides the level Vᵢ, a first sample is tapped off from the sampling capacitor C1 by actuating the transistor TDS1 through the command CDS1. This command CDS1 is a pulse that remains active for a microsecond for example.

When the signal Vs provides the level V_{f}, a second sample is tapped off from the sampling capacitor C2 by actuating the transistor TDS2 through the command CDS2. This command CDS2 is likewise a sampling pulse that remains active likewise for approximately one microsecond. Eventually, the useful signal is available at the instants of deactivation of signals CDS1 and CDS2 in the form of the differential voltage ΔV present between the two sampling capacitors C1 and C2. Also, it is this differential voltage that will for example be amplified in the readout means MLCT.

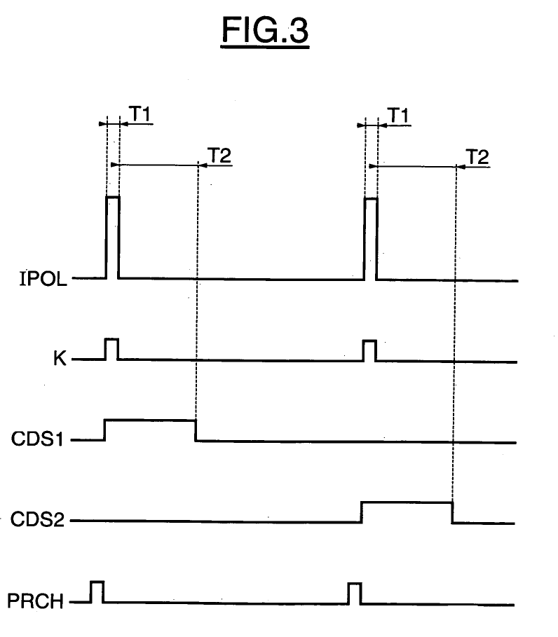

Relative to a conventional manner of operation of this type, the manner of operation of the invention will now be described while referring more particularly to FIG. 3, in which the sampling pulses CDS1 and CDS2 have in particular been reproduced. The duration T of each sampling pulse has been held at one microsecond.

It may be seen in particular in this FIG. 3 that the bias current IPOL, delivered by the current source PLS, is provided only for a small fraction T1 of the duration of each sampling pulse CDS1, CDS2. This current IPOL is thereafter cut off by means of the interrupter ITS controlled by the control signal K.

This first duration T1 is predetermined so as to obtain for the sampling capacitor concerned, a stable final state of charge. In the preferred mode of implementation that is described here, the nominal value of the bias current I_{POL} is much greater than that used in conventional architectures, typically of the order of 10 to 20 times larger. This allows the level of the voltage V_{BL} to be stabilized all the more rapidly. By way of example, for a sampling pulse of the order of one microsecond, the first duration T1 is for example of the order of 100 nanoseconds with a bias current of the order of 10 microamperes.

On completion of the duration T1 there is a stable final state of charge in the sampling capacitor concerned, that is to say a zero current through this sampling capacitor, to within a tolerance.

When the bias current I_{POL} is cut off, a very rapid decay of the current then occurs over the second duration T2 equal to T−T1. The gate-source voltage of the follower transistor then goes from

$$Vt + \sqrt{\frac{{I}_{POL}}{K}}$$

to the threshold voltage Vt, K being a technological constant.

There is therefore less gate-source voltage, thereby making it possible to utilize more useful signal without clipping.

Moreover, the white noise contributions due to the bias current (follower transistor and current source) disappear with the latter, hence resulting in reduced sampling noise.

More precisely, when the current is cut off, the potential V_{BL} of the bit line BL goes, depending on the value Vᵢ or V_{f} of the pixel voltage, from

$${V}_{i , f} - Vt - \sqrt{\frac{{I}_{POL}}{K}}$$

to V_{i,f}−Vt.

The voltage variation is positive and the current required to produce this variation passes through the follower transistor. This current rapidly attains a very low value (typically less than 100 nanoamperes), and the follower transistor is weakly reverse-biased. In this operating zone, the noise band is much reduced and the noise spectral density exhibits a low amplitude, hence a considerable improvement in the noise.

It is also particularly advantageous, although not indispensable, to impart a deterministic state to each sampling capacitor before each sampling. A solution then consists, as illustrated in FIG. 3, in precharging the sampling capacitors C1 and C2 to a zero voltage before each sampling pulse.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A process for sampling the signal delivered by an active pixel of an image sensor comprising a phase of storage of the signal in a pair of sampling capacitors comprising two successive respective effective electrical links of the two sampling capacitors with a follower transistor tracking the pixel in the course of the two respective sampling pulses corresponding respectively to two successive different levels of pixel voltage that are applied to a gate of the follower transistor, wherein the process for the storage phase comprises for each sampling capacitor:
applying to this sampling capacitor a voltage equal to the corresponding pixel voltage minus the gate-source voltage of the follower transistor biased with a predetermined constant bias current for a first predetermined duration so as to obtain for the said sampling capacitor a final state of stable charge;
interrupting the bias current; and
ending the sampling pulse on completion of a second predetermined duration after the said interruption of the current.

2. The process according to claim 1, wherein the second duration is chosen in such a way as to obtain at the end of the said sampling pulse, a residual current flowing through the follower transistor less than a predetermined threshold corresponding to a predetermined threshold level of the noise of the follower transistor.

3. The process according to claim 2, wherein the predetermined threshold level for the noise of the follower transistor lies between approximately 50 and 100 microvolts.

4. The process according to claim 1, wherein the first duration is a fraction of the duration of the said sampling pulse, the bias current then being greater than a predetermined threshold.

5. The process according to claim 4, wherein the duration of the sampling pulse is of the order of one microsecond, the first duration is of the order of 100 nanoseconds, and the bias current is of the order of 10 microamperes.

6. The process according to claim 1, wherein each sampling capacitor is precharged to a predetermined initial value before each sampling pulse.

7. An image sensor, comprising:
a matrix of active pixels;
means for processing information delivered by the matrix of active pixels, the processing means comprising:
a pair of sampling capacitors per column of the matrix that are able to be respectively linked electrically to a follower transistor tracking each pixel of the column in the course of two respective sampling pulses corresponding respectively to two successive different levels of pixel voltage that are applied to a gate of the follower transistor;
a current source connected to each column of the matrix, and able to deliver on command to the column a predetermined constant bias current; and
control means operable for each sampling capacitor and in the course of the corresponding sampling pulse to:
energize the column with the bias current for a first predetermined duration so as to obtain for the said sampling capacitor a final state of stable charge;
interrupt the energizing of the column by the bias current; and
end the sampling pulse on completion of a second predetermined duration after the interruption of the current.

8. The sensor according to claim 7, wherein the second duration is chosen in such a way as to obtain at the end of the sampling pulse, a residual current flowing through the follower transistor less than a predetermined threshold corresponding to a predetermined threshold level of the noise of the follower transistor.

9. The sensor according to claim 8, wherein the predetermined threshold level for the noise of the follower transistor lies between approximately 50 and 100 microvolts.

10. The sensor according to claim 7, wherein the first duration is a fraction of the duration of the sampling pulse, the bias current then being greater than a predetermined threshold.

11. The sensor according to claim 10, wherein the duration of the sampling pulse is of the order of one microsecond, the first duration is of the order of 100 nanoseconds, and the bias current is of the order of 10 microamperes.

12. The sensor according to claim 7, wherein the current source is connected to the said column by an interrupter controllable by the control means.

13. The sensor according to claim 7, wherein the processing means comprise precharging means able to precharge each sampling capacitor to a predetermined initial value before each sampling pulse.

14. The sensor according to claim 13, wherein each sampling capacitor possesses a terminal linked to ground, and the precharging means comprise two additional controllable interrupters able to link respectively the other two terminals of the two sampling capacitors to ground.

15. A circuit, comprising:
a pixel sensor;
a transistor coupling the pixel sensor to a bit line;
a first sampling capacitor selectively coupled to the bit line;
a second sampling capacitor selectively coupled to the bit line;
a bias current generator selectively coupled to the bit line;
a control circuit operable to selectively couple the bit line to the first sampling capacitor during a first sample period and selectively couple the bit line to the second sampling capacitor during a second sample period, the control circuit further operable, during each of the first and second sample periods, to selectively couple the bias current generator to the bit line to bias the transistor into a follower configuration.

16. The circuit of claim 15 wherein the control circuit selectively couples the bias current generator to the bit line at a beginning of each of the first and second sample periods.

17. The circuit of claim 16 wherein the control circuit de-couples the selectively coupled bias current generator from the bit line before an end of each of the first and second sample periods.

18. The circuit of claim 17, wherein each first and second sampling period is of the order of one microsecond, and a duration of the selective coupling of the bias current generator is of the order of 100 nanoseconds.

19. A method for capacitively sampling a pixel sensor coupled to a bit line through a transistor, comprising:
initiating a sample period by applying a bias current to the bit line and coupling the bit line to a sensing capacitor;
after a first time period, terminating application of the bias current; and
after a subsequent second time period decoupling the sensing capacitor from the bit line to terminate the sample period.

20. The method of claim 19 wherein the bias current biases the transistor into a follower configuration.

21. The method of claim 19 wherein a length of the first time period is chosen to allow the sensing capacitor to reach a substantially stable charge state.

22. The method of claim 21 wherein the length of the first time period is approximately 100 nanoseconds.

23. The method of claim 19 wherein the bias current has a value on the order of 10 micro-amperes.

24. The method of claim 19 wherein the sample period has a length on the order of about one microsecond.

25. The method of claim 19 further comprising:
performing the initiating, terminating and decoupling operations to measure an initial pixel voltage; and
repeating the initiating, terminating and decoupling operations to measure a final pixel voltage.

26. A circuit, comprising:
a pixel sensor;
a transistor coupling the pixel sensor to a bit line;
a sampling capacitor selectively coupled to the bit line;
a bias current generator selectively coupled to the bit line;
a control circuit operable to selectively couple the bit line to the sampling capacitor during a sample period, the control circuit further operable to selectively couple the bias current generator during the sample period to the bit line to bias the transistor into a follower configuration.

27. The circuit of claim 26 wherein the control circuit selectively couples the bias current generator to the bit line at a beginning of the sample period.

28. The circuit of claim 27 wherein the control circuit de-couples the selectively coupled bias current generator from the bit line before an end of the sample period.

29. The circuit of claim 28, wherein the sampling period is of the order of one microsecond, and a duration of the selective coupling of the bias current generator is of the order of 100 nanoseconds.
